(19) United States
(12) Patent Application Publication
(10) Pub. No.: US 2023/0372879 A1
(43) Pub. Date: Nov. 23, 2023

(54) HYDROPHILIC MEMBRANES FOR FILTRATION

(71) Applicant: ENTEGRIS, INC., Billerica, MA (US)

(72) Inventors: Ying Qi, Westford, MA (US); James Hamzik, North Billerica, MA (US); Lucas Benjamin Snyder, Lowell, MA (US); Saksatha Ly, Lexington, MA (US)

(21) Appl. No.: 18/199,204

(22) Filed: May 18, 2023

Related U.S. Application Data
(60) Provisional application No. 63/343,827, filed on May 19, 2022.

(51) Int. Cl. B01D 69/02; B01D 71/36

(52) U.S. Cl. CPC B01D 69/02; B01D 71/36; B01D 2325/02834; B01D 2325/24; B01D 2257/91

(57) ABSTRACT

The disclosure provides porous membranes capable of removing very small particulates from a liquid composition. In certain embodiments, the porous membranes comprise poly(tetrafluoroethylene), wherein the membrane is at least partially coated with a polymer prepared from the free radical reaction of ethylenically-unsaturated monomers, wherein the monomers are comprised of monomers having an amide moiety. In particular embodiments, the membranes are capable of removing, by filtration, microbial particles such as bacteria, thus rendering the resulting liquid composition essentially sterile.

### TECHNICAL FIELD

The disclosure relates generally to hydrophilic-modified porous membranes, such as filter membranes, and to methods of using such membranes to remove extremely small particulates and/or microbial species from liquid compositions.

### BACKGROUND

Filters are used to remove unwanted materials from a flow of a useful liquid solution and have become important features in a wide variety of technologies. Liquid solutions that are treated to remove unwanted materials include water, liquid industrial solvents and processing fluids, industrial gases used for manufacturing or processing, and liquids that have medical or pharmaceutical uses. Unwanted materials that are removed from fluids include impurities and contaminants such as particles, microorganisms, and dissolved chemical species. Specific examples of filter applications include their use with liquid materials for semiconductor and microelectronic device manufacturing, along with sterilizing filtration for liquid solutions intended for introduction to the human body.

Filters can remove unwanted materials by a variety of different ways, such as by size exclusion or by chemical and/or physical interaction with material. Some filters are defined by a structural material providing a porous architecture to the filter, and the filter is able to trap particles of a size that are not able to pass through the pores. Some filters are defined by the ability of the structural material of the filter, or of a chemistry associated with the structural material, to associate and interact with materials that pass over the filter. For example, chemical features of the filter may enable association with unwanted materials from a stream that passes over the filter, trapping those unwanted materials such as by ionic, coordinative, chelation, or hydrogen-bonding interactions. Some filters can utilize both size exclusion and chemical interaction features to remove materials from a filtered stream.

In some cases, to perform a filtration function, a filter includes a filter membrane that is responsible for removing unwanted material from a fluid that passes through. The filter membrane may, as required, be in the form of a flat sheet, which may be wound (e.g., spirally), flat, pleated, or disk-shaped. The filter membrane may alternatively be in the form of a hollow fiber. The filter membrane can be contained within a housing or otherwise supported so that fluid that is being filtered enters through a filter inlet and is required to pass through the filter membrane before passing through a filter outlet.

Certain filters are capable of removing very small particulate matter and microbial contaminants such as bacteria, thus rendering the filtered liquid solution essentially sterile. In such applications, it is also essential that the filter media or membrane perform such that very low amounts of extractible or leachable materials are found to exude from the filter which may otherwise foul the filtered liquid solution. Additionally, in the case of sterilization filtration, it is also essential that the filter not unduly retain desired components of the liquid composition, such as active pharmaceutical ingredients (API's).

### SUMMARY

In summary, the disclosure provides porous membranes capable of removing very small particulates from a liquid composition. In certain embodiments, the porous membranes comprise poly(tetrafluoroethylene), wherein a) the membrane is at least partially coated with a polymer prepared from the free radical reaction of ethylenically-unsaturated monomers, wherein the monomers are comprised of monomers having an amide moiety; b) the membrane exhibits a wettability of at least about 80 Dynes/cm; and c) the membrane exhibits a 60% isopropanol visual bubble point of greater than about 21 psi.

In certain embodiments, the membranes possess average pore sizes of about 0.1 μm to about 0.2 μm. In particular embodiments, the membranes are capable of removing, by filtration, microbial particles such as bacteria, thus rendering the resulting liquid composition essentially sterile. Also in particular embodiments, the coating on the porous membrane allows for the filtration of the liquid composition without unduly retaining active pharmaceutical ingredients contained therein, in particular, those active pharmaceutical ingredient(s) having ionizable nitrogen groups, such as quaternary ammonium groups.

### BRIEF DESCRIPTION OF THE DRAWINGS

FIG. 1 is a plot of the wettability (Dynes/cm) comparing a membrane of the disclosure (A) versus a commercial membrane, (B) Cobetter Hydrophilic PTFE, having a pore size of 0.2 μm.

FIG. 2 is a comparison of the 60% isopropanol visual bubble point in psi (pounds per square inch) for a membrane of the disclosure (A) versus a commercial membrane, (B) Cobetter Hydrophilic PTFE, having a pore size of 0.2 μm.

FIG. 3 is a comparison of the deionized water (DIW) flow time of a membrane of the disclosure (A) versus a commercial membrane, (B) Cobetter Hydrophilic PTFE, having a pore size of about 0.2 μm.

FIG. 4 is depiction of data for NVR (non-volatile residue) for a membrane of the disclosure (A) versus a commercial membrane, (B) Cobetter Hydrophilic PTFE, having a pore size of about 0.2 μm.

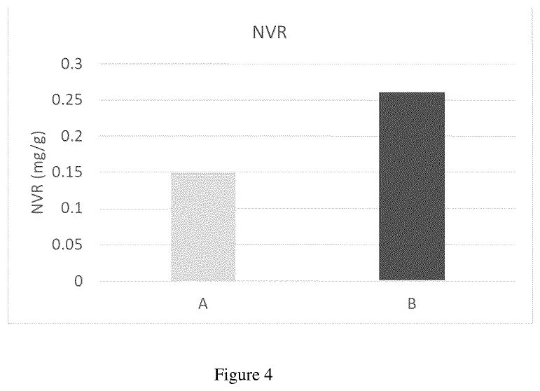

FIG. 5 is a depiction of an exemplary filter device comprising a membrane of the disclosure.

### DETAILED DESCRIPTION

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

The term “about” generally refers to a range of numbers that is considered equivalent to the recited value (e.g., having the same function or result). In many instances, the term “about” may include numbers that are rounded to the nearest significant figure.

Numerical ranges expressed using endpoints include all numbers subsumed within that range (e.g., 1 to 5 includes 1, 1.5, 2, 2.75, 3, 3.80, 4 and 5).

In a first aspect, the disclosure provides a porous membrane comprising poly(tetrafluoroethylene), wherein a) the membrane is at least partially coated with a polymer prepared from the free radical reaction of ethylenically-unsaturated monomers, wherein the monomers are comprised of monomers having an amide moiety; b) the membrane exhibits a wettability of at least about 80 Dynes/cm; and c) wherein the membrane exhibits a 60% isopropanol visual bubble point of greater than about 21 psi.

In certain embodiments, the membrane of the disclosure exhibits a deionized water flow time of about 200 to about 400 seconds per 500 ml, about 200 to about 350 seconds per 500 ml, about 250 to about 400 seconds per 500 ml, or any and all ranges therebetween.

In certain embodiments, the porous membrane of the disclosure is about 0.1 μm to about 0.2 μm, or about 0.15 μm to about 0.22 μm.

The membranes of the disclosure are capable of removing extremely small contaminants from a variety of solutions. Exemplary contaminants include particulates and microbial species such as bacteria. In one embodiment, the mean pore size of the membrane is no greater than about 0.22 μm. in other embodiments, the mean pore size of the membrane is about 0.1 to about 0.22 μm or about 0.15 μm to about 0.22 μm or any and all ranges therebetween.

The membranes of the disclosure are useful with any type of process which requires a high purity liquid material. The membranes of the disclosure are thus useful in a variety of applications, for example those including liquids used on semiconductor photolithography, diagnostic applications (e.g., sample preparation and/or diagnostic lateral flow devices), ink jet applications, filtering fluids for the pharmaceutical industry, filtering fluids for medical applications, e.g., intravenous applications such as blood (e.g., removal of leukocytes), filtering fluids for the electronics and semiconductor industries, filtering fluids for the food and beverage industry, clarification, and filtering antibody- and/or protein-containing fluids.

In one embodiment, the membranes of the disclosure are useful in removing microbial contaminants such as bacteria from various solutions.

Exemplary solutions where the removal of bacteria is necessary and desirable includes those pharmaceutical formulations designed to be administered directly to a patient (i.e., in vivo), for example via subcutaneous, intramuscular, or intravenous injection. Often, these solutions are primarily aqueous in nature and composition, but may also contain, in addition to the active pharmaceutical ingredient (API) (such as a parenteral antibiotic), materials such as pharmaceutically-acceptable carriers and/or diluents.

Thus, in a further aspect, the disclosure provides a method for filtering a liquid, which comprises passing the liquid through the membranes of the disclosure. In certain embodiments, the disclosure includes a method for removing bacteria from a liquid comprising at least one active pharmaceutical ingredient (API) and one or more diluents, which comprises passing the liquid solution through the membranes of the disclosure.

In general, pharmaceutically acceptable carriers and/or diluents include any material which is generally inert, i.e., it has no therapeutic effect in and of itself, while also being sufficiently non-toxic in the amounts utilized in the formulation containing the active pharmaceutical ingredient. Exemplary solvents, suspending media, dispersing agents, carriers and diluents, etc., can be found in U.S. Pat. No. 10,137,132, incorporated herein by reference in its entirety.

Such carriers and/or diluents include materials such as ethanol, water, glycerol, propylene glycol, glycerin, diethylene glycol, monoethylether, Vitamin A and Vitamin E oils, mineral oil, PPG2 myristyl propionate, magnesium carbonate, potassium phosphate, silicon dioxide, vegetable oils such as castor oil and derivatives thereof, plant gums, gelatin, animal oils, solketal, calcium carbonate, dibasic calcium phosphate, tribasic calcium phosphate, calcium sulfate, microcrystalline cellulose, powdered cellulose, dextrans, dextrin, dextrose, fructose, kaolin, lactose, mannitol, sorbitol, starch, pre-gelatinized starch, sucrose, sugar, etc.

In other embodiments, the membranes of the disclosure are useful in the filtration of liquid compositions used in the fabrication of microelectronic devices, such in photolithography. In such applications, liquid compositions include solvents such as n-butyl acetate, isopropyl alcohol, 2-ethoxyethyl acetate, xylenes, cyclohexanone, ethyl lactate, isopentyl ether, methyl-2-hydroxyisobutyrate, methyl isobutyl carbinol, methyl isobutyl ketone, isoamyl acetate, undecane, propylene glycol methyl ether, propylene glycol monomethyl ether acetate (PGMEA), and a mixed solution of propylene glycol monomethyl ether and PGMEA (7:3).

As noted above, the porous membranes are capable of performing as sterilizing membranes (i.e., bacteria-removing) while not unduly retaining the desired API's which are in solution. In general, the membranes are rendered relatively hydrophilic by the coating described herein, thus also affording utility in the sterilizing filtration of aqueous-based liquids, while not unduly retaining certain active pharmaceutical ingredients, in particular those which contain ionizable nitrogen groups, such as quaternary ammonium groups. This hydrophilicity characteristic is quantified herein by the recitation of the wettability of the membranes. In particular embodiments, the membrane exhibits a wettability of at least about 80 Dynes/cm, for example about 82 to about 89 Dynes/cm.

As noted above, the membranes of the disclosure comprise a coating prepared from the free-radical polymerization of ethylenically-unsaturated monomers, wherein the monomers comprise monomers possessing an amide moiety. In certain embodiments, the introduction of a hydrophilic coating having amide moieties is conducted in order to provide a coating which has an amide density (AD) of about 0.008 to about 0.014, or about 0.01 to about 0.013. In this regard, an amide density (AD) for the coated membranes of the disclosure can be defined as AD=(number of amide moieties per monomeric unit per molecular weight of the monomeric unit).

Exemplary monomers include those acrylic esters, methacrylic esters, and vinyl esters which possess an amide moiety, and include, for example, ethyl acrylamide, butyl acrylamide, N, N-dimethylaminopropyl methacrylamide, acrylamide, methacrylamide, ethyl formamide, N-(2-methoxyacrylamido-ethyl)ethylene urea, N,N-methylenebisacrylamide, and dimethylacrylamide. In other embodiments, at least about 90 mole percent of the monomers possess an amide moiety. In certain embodiments, these monomers are chosen from N, N-methylenebisacrylamide and dimethylacrylamide, or a combination thereof. In other embodiments, the coatings so formed on the membranes of the disclosure are prepared from N,N-methylenebisacrylamide and dimethylacrylamide and are used in a weight ratio of about 1:1 to about 1:4, or about 1:2.5.

As a consequence of the sterilizing filtration of the liquid compositions comprising active pharmaceutical ingredient(s), the porous membranes of the disclosure are believed to be effective in retaining only small proportions of such active pharmaceutical ingredients, in particular those containing ionizable nitrogen functional groups such as quaternary ammonium groups. At the same time, the membranes of the disclosure also generate very small amounts of extractible materials from the membranes.

The membranes of the disclosure can be prepared by coating a poly(tetrafluoro ethylene) membrane with an amide-functional polymer, such as one prepared by the free radical reaction of ethylenically-unsaturated monomers, at least some of which monomers contain amide functional groups or moieties. Advantageously, one such amide functional monomer, a dialkylacrylamide such as dimethylacrylamide may be utilized, in conjunction with a difunctional amide functional monomer, such as N, N-methylenebisacrylamide. In this fashion, N, N-methylenebisacrylamide thus serves the function of a crosslinker. In general, a mixture of the monomers, along with a free-radical polymerization initiator are dissolved in an inert solvent and brought into contact with the poly(tetrafluoroethylene) membrane thereby forming a polymeric coating having amide functionality on the various surfaces of the poly(tetrafluoroethylene) membrane. The monomers are generally utilized in solution in concentrations of about 1 to about 20 percent by weight of the reactant solution. A polymerization initiator is generally present in amounts of about 0.25 to about 2.5 percent by weight of the reactant solution. Suitable initiators are well-known and include common free radical initiators such as azobisisobutyronitrile (AIBN) or a photoinitiator such as Irgacure 2959, (2-hydroxy-4′-(2-hydroxyethoxy)-2-methylpropiophenone). Alternately, the membrane can be immersed in the reaction solution referred to above and exposed to ultraviolet radiation to initiate the polymerization reaction and hence the coating of the membrane.

By virtue of this coating, the poly(tetrafluoroethylene) membrane, which is hydrophobic, is rendered hydrophilic by this coating process. If it is desired to reduce the proportion of amide-functional groups on the coating, other ethylenically-unsaturated monomer species may be utilized along with the amide-functional monomers. In certain embodiments, greater than 90% of the monomers utilized to form the coating are monomers which contain an amide functionality or moiety.

The porous membranes of the disclosure can be characterized with reference to one or more properties or performance characteristics of the membrane, such as pore size, 60% isopropanol visual bubble point, wettability, retention of active pharmaceutical ingredient(s), and extractible materials produced by the membrane.

Pore size can be measured by known techniques such as Mercury Porisometry (MP), Scanning Electron Microscopy (SEM), Liquid Displacement (LLDP), or Atomic Force Microscopy (AFM).

With regard to 60% isopropanol visual bubble point, this characteristic can be measured in the following manner: first, a 47 mm membrane coupon was placed on in a holder and the membrane wetted using 60% IPA in water. Air pressure is then applied to the membrane until a bubble can been seen from top of the holder. The pressure is recorded as visual bubble point (VBP). This observable VBP correlates to the membrane's pore size. In some embodiments, the VBP is greater than about 21 psi, 22 psi, 23 psi, 24 psi, 25 psi, or 26 psi, 27 psi, 28 psi, 29 psi, or 30 psi.

With regard to wettability, this characteristic can be measured in the following manner: Solutions are prepared that correspond to different surface tension 20%, 22%, 24%, 26%, 28% NaCl solution, and 30%, 32%, 34%, 36%, 38%, 40%, 42% CaCl₂) solution. Each solution corresponds to different surface tension. Transfer pipets were used to drop a few droplets of solution of specific concentration to the surface of the membrane; if droplet wet membrane surface within 10 seconds, the membrane was considered wettable in the solution that correspond to specific surface tension. In one embodiment, the membrane exhibits a wettability of at least about 80 Dynes/cm, for example about 82 to about 89 Dynes/cm.

The efficacy of the porous membranes of the disclosure in serving to remove bacteria, a Bacterial Challenge Test, per ASTM FM838-20 is utilized.

Also important in the case of sterilization filtration of liquid solutions designed for in vivo use, is the membrane's performance in not retaining active pharmaceutical ingredients in the liquid solution as such a tendency would be self-defeating.

The porous membranes of the disclosure can be of any desired geometric configuration suitable for filtration of a liquid solution, for example, circular, semi-circular, oval, semi-oval, or polygonal such as square, rectangular, hexagonal, or octagonal, etc. The porous membranes can be in the form of a flat sheet, a corrugated sheet, a pleated sheet, a hollow fiber, etc.

The porous membranes of the disclosure can be associated with a support structure, a housing, or both. For example, the membranes can be supported by a frame, bracket, clip, web, net, cage, and the like. In some embodiments, at least part of the support structure is a housing; in other embodiments, the porous membrane is unsupported.

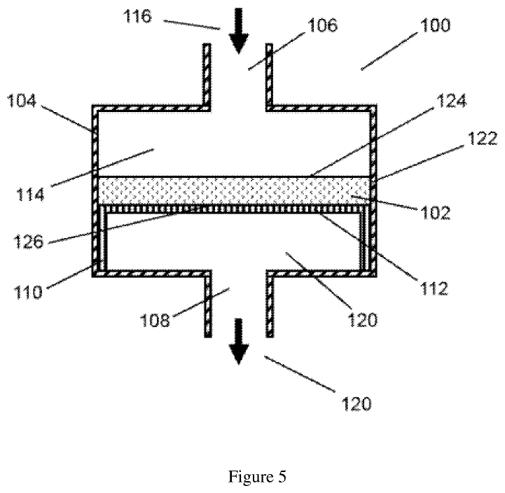

An embodiment of the disclosure includes a filter device and a method of removing contaminants from a liquid, wherein the liquid is passed through the membrane of the disclosure. As shown in FIG. 5, the disclosure provides a filter 100 that includes a porous membrane 102. The porous membrane 102. The filter 100 can have a housing 104 that provides a structure to the filter 100 and that fluidically seals an internal portion of the filter. The housing 104 can be any shape and size, such as cylindrical, polygonal, etc.

One portion of the filter can include an inlet port 106, to receive a liquid composition to be filtered. The inlet port 106 can be configured to be connected to a fluid supply line. As such, the inlet port 106 can include a valve, a gasket, etc. (not shown) to facilitate connection to a fluid supply. The liquid composition to be filtered can flow through inlet port 106 in direction indicated by arrow 116, and into a headspace 114 in the filter 100, as defined by an input-facing surface 124 of porous membrane 102, the internal surface of the housing 104, and the inlet port 106. In embodiments, the filter can be constructed so the headspace has a volume that is a desired percentage of the total internal volume of the filter.

The internal portion of the filter can include the porous membrane in any suitable placement or arrangement, with FIG. 5 showing the porous membrane 102 having a disc-like architecture (a cross-sectional view is shown). A side 122 of the porous membrane 102, such as the outer circumference of the membrane, can be in contact with the inner surface of the housing 104. The porous membrane 102 can also have an input-facing surface 124, which first contacts the liquid, and an output-facing surface 126, from which treated liquid with reduced amounts of particulate or bacterial flow. Aspects of the filter can optionally be described in terms of the range of the ratio of the surface area of the input-facing surface 124 to the volume of the porous membrane 102, or the ratio of the surface area to the thickness of the filter.

The filter 100 can also include one or more features that support the porous membrane 102 within the filter. Any arrangement for supporting the filter can be used and can include one or more distinct structural feature(s), such as a frame, frame, bracket, clip, web, net, and cage, and the like, or a material such as an adhesive can be used to support the membrane. A combination of an adhesive and a structural supporting feature can be used. In an embodiment, and with reference to FIG. 5, the filter includes a frame having frame portions 110 and 112, with frame portion 110 in contact with the inner surface of the housing 104, which is attached to portion 112. Portion 112 can be in contact with the output-facing surface 124 of the porous membrane 102 and can provide support to the membrane during filtering. Frame portion 112 can have a grid-like structure to freely allow filtered liquid to pass into the backspace 120 of the filter, while still providing structural support to the porous membrane under increased fluidic pressures.

In use, a liquid enters the filter through inlet port 106 in direction indicated by arrow 116, and then fills the headspace 114 within the filter 100. Sufficient fluidic pressure is applied to cause the fluid to move through the porous membrane at a desired flow rate.

### EXAMPLES

### Example 1

This example demonstrates how a porous polytetrafluoroethylene (PTFE) membrane can be surface modified with a hydrophilic coating having polymerized monomer with an amide group.

A surface modification monomer solution was made which includes: 0.3% Irgacure 2959, (2-hydroxy-4′-(2-hydroxyethoxy)-2-methylpropiophenone); 10% Methanol, 1.71% dimethylacrylamide (DMAM), 0.69% N,N-methylene bisacrylamide (MBAM), 87.3% deionized water.

The hydrophilic PTFE membrane was prepared by the following method. First, a 47 mm disk of PTFE porous membrane (60 um thick, 0.15-0.2 μm pore size) was wet with isopropanol (IPA) solution for 25 seconds. Next, an exchange solution comprising 10% hexylene glycol and 90% water was used to rinse the membrane and remove IPA. The porous membrane disk was then introduced into the surface modification monomer solution and remained submerged for 2 minutes. The porous membrane disk was removed from the surface modification monomer solution and placed between transparent polyethylene sheets. Any excess solution was removed by rolling a rubber roller over the polyethylene/membrane disk/polyethylene sandwich as it lays flat on a table. The polyethylene sandwich was then taped to a transport unit which conveyed the assembly through a Fusion Systems broadband UV exposure lab unit emitting at wavelengths from 200 to 600 nm. Time of exposure was controlled by how fast the assembly moves through the UV unit. In this example, the assembly moved through the UV chamber at 10 feet per minute. After emerging from the UV unit, the membrane was removed from the sandwich and immediately placed in DI water, where it was allowed to soak for 5 minutes. Next, the treated membrane sample was transferred to methanol and allowed to soak for 5 minutes. Following this soaking procedure the membrane was dried on a holder in an oven operating at 50° C. for 10 min. Water flowtime of the membrane modified as described above was 300 sec/500 mL. The resulting membrane was hydrophilic and spontaneously wet when submerged in deionized water.

Bacterial Challenge Test

The bacterial retention test is based on ASTM FM838-20.

The pressure vessel and the upstream connecting tubing do not need to be autoclaved, but should be thoroughly cleaned, disinfected, and flushed with sterile pure water prior to the test. The vessel may be disinfected with a 0.005% sodium hypochlorite solution made of 1:999 dilution of 5% sodium hypochlorite solution or 70% ethanol, drained, and rinsed thoroughly with sterile pure water. Two groups of the membranes of the disclosure were installed in a test analysis filter assembly and then autoclaved at 121° C. for 30 min. One group used as it is, the other group was treated with test product liquid for 18 hours at 38° C.

The pre-test bubble point of the membrane was collected using an automatic integrity tester. Sterile 0.9% NaCl solution was added into the pressure vessel to wet the test membrane. Next, 20-50 mL filtrate was collected from the downstream by an analytical membrane as a negative control analysis membrane.

For positive control testing, bacteria retention test of 0.45 μm positive control filter cartridge (filter membrane or filter assembly) should be performed and challenge level should be not less than 1×10⁷ cfu/cm². The positive control sample was collected from the control analysis filter assembly downstream using an analytical membrane. At room temperature, the membrane of the disclosure was subjected to bacterial retention using sterile 0.9% NaCl solution which was inoculated with B. diminuta. The test sample was collected from the test filter assembly downstream using an analytical membrane. After the test challenge, the analytical membranes were aseptically transferred to a PCA plate and incubated at 30±2° C. Next, the colony counts of negative control analysis membranes were recorded at 72 hours and at 7 days, colony counts of test analysis membranes at 48 hours and at 7 days, and colony counts of positive control analysis membranes at 48 hours. The post-test membranes were then autoclaved at 121° C. for 30 min. The bubble point of the test membranes was then measured with the automatic integrity tester as post-test bubble point.

Table 1 below summarizes the average membrane bacterial challenge test result and shows all the tested membranes of the disclosure can retain a >10⁷ cfu/cm² EFA level challenge of B. diminuta after one autoclave cycle of 30 minutes at 121° C.

TABLE 1

| | Pressure | | | |
|---|---|---|---|---|
| | testing | Flow Rate | | |
| | condition | (2-4 | Bacterial | |
| Example | (bar) | mL/minute/cm² | Concentration | Pass/Fail |
| 1 | 2.0 | 2.35 | 1.3 × 10⁸ | Pass |
| | 2.0 | 2.34 | 1.3 × 10⁸ | Pass |
| | 2.0 | 3.02 | 1.3 × 10⁸ | Pass |
| 2 | 2.0 | 3.11 | 1.3 × 10⁸ | Pass |
| | 2.0 | 2.65 | 1.3 × 10⁸ | Pass |
| | 2.0 | 2.54 | 1.3 × 10⁸ | Pass |
| 3 | 2.0 | 3.16 | 1.3 × 10⁸ | Pass |
| | 2.0 | 3.46 | 1.3 × 10⁸ | Pass |
| | 2.0 | 3.08 | 1.3 × 10⁸ | Pass |
| 4 | 2.0 | 2.49 | 1.3 × 10⁸ | Pass |
| | 2.0 | 3.11 | 1.3 × 10⁸ | Pass |
| | 2.0 | 3.96 | 1.3 × 10⁸ | Pass |

Wettability Testing

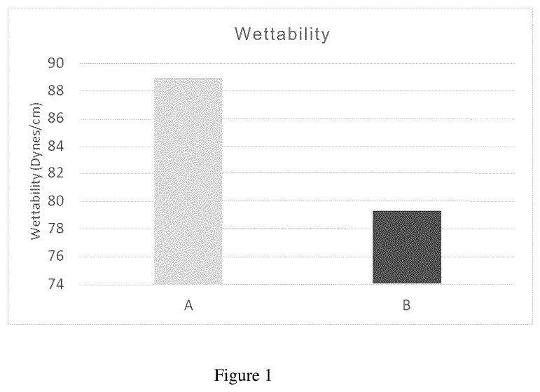

Solutions are prepared that correspond to different surface tension 20%, 22%, 24%, 26%, 28% NaCl solution, and 30%, 32%, 34%, 36%, 38%, 40%, 42% CaCl₂ solution. Each solution corresponds to different surface tension as listed in Table 2 below. Transfer pipets were used to drop a few droplets of solution of specific concentration to the surface of the membrane; if droplet wet membrane surface within 10 seconds, the membrane was considered wettable in the solution that correspond to specific surface tension. FIG. 1 shows the wettability of the membrane of the disclosure (A) is greater than a commercial membrane (B), the Cobetter Hydrophilic PTFE membrane having a pore size of 0.2 μm. As can be seen, the membrane of the disclosure can have a wettability of at least about 80 Dynes/cm.

TABLE 2

| % NaCl | Dynes/cm |
|---|---|
| 1.46 | 73 |
| 4.12 | 74 |
| 6.78 | 75 |
| 9.48 | 76 |
| 12.11 | 77 |
| 14.77 | 78 |
| 17.43 | 79 |
| 20.09 | 80 |
| 22.75 | 81 |
| 25.42 | 82 |
| 26.5 | 83 |
| % CaCl | Dynes/cm |
| 32.18 | 87 |
| 33.4 | 88 |
| 34.6 | 89 |
| 35.9 | 90 |
| 38.44 | 92 |
| 42.25 | 95 |
| 42.47 | 96 |
| 44 | 100 |

60% IPA Visual BP Test

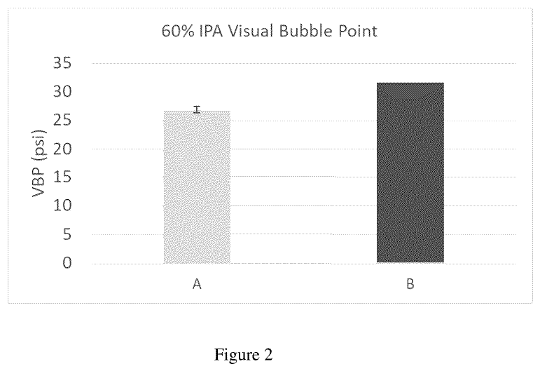

First, a 47 mm membrane coupon was placed on in a holder and the membrane wetted using 60% IPA (isopropanol) in water. Air pressure was applied to the membrane until a bubble can been seen from top of the holder. The pressure is recorded as visual bubble point (VBP). FIG. 2 shows the 60% IPA VBP of the membrane of the disclosure (A) is less than the Cobetter Hydrophilic PTFE membrane (B) having a pore size of about 0.2 μm. As can be seen, the membrane of the disclosure can have 60% IPA VBP greater than about 21 psi.

Water Flow Time Test

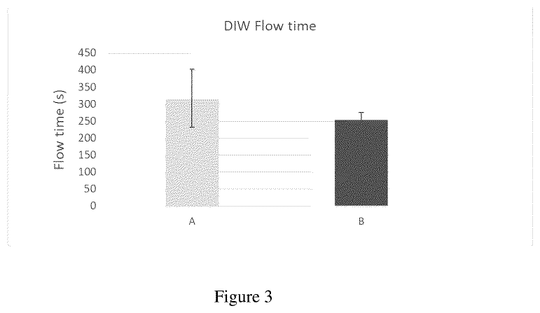

Deionized water (DIW) flow time was tested in a DIW flow tester, which equipment records the time of flowing 500 mL DIW through a 47 mm membrane coupon. FIG. 3 shows the DIW flow time of the membrane of the disclosure is greater than the commercial PTFE membrane Cobetter Hydrophilic PTFE membrane having a pore size of 0.2 μm. As can be seen, the membrane of the disclosure can have a DIW flow time in a range of about 200 to about 400 seconds per 500 ml.

Extractible Materials Test

The membranes were placed into a cartridge device and extracted in 50% ethanol, at 80° C., for 24 hours agitating with a magnetic stirring rod at 50 rpm. Extractable tests results set forth below in Table 3 include non-volatile residue (NVR), UV, pH, LC, GC-MS and ICP-MS measurement. In Table 3 NMT means no more than.

The NVR test for membranes A and B having a size 30 cm by 30 cm were extracted in 250 mL 100% isopropyl alcohol for 24 hours. The membrane of the disclosure (A) showed lower NVR (0.15 mg/g) compared to membrane B (0.26 mg/g).

TABLE 3

| Extraction | Extraction | | | Acceptance | |
|---|---|---|---|---|---|
| Solution | Condition | Test Item | Data | Criteria | Conclusion |
| 50% | 80° C., 24 | NVR | 53.2 mg/pc | For | NA |
| ethanol in | hours, | | | Reference | |

| | | | | | |
|---|---|---|---|---|---|
| water | agitating at | Change in pH | 0.54 | NMT 2 | Pass |
| | 50 rpm | UV | Wavelength | For | NA |

| | | between | reference | |
|---|---|---|---|---|
| | | 210~300 nm, | | |
| | | maximum | | |
| | | absorbance | | |
| | | at 0.65 Au | | |
| Elemental Compounds | | Max 0.00003 | NMT 0.1 | Pass |
| by ICP-MS | | μg/g | μg/day | |
| Organic | Suspected | Max 0.01 | NMT 1.5 | Pass |
| compounds | genotoxic | μg/day | μg/day | |
| by HPLC, | risk | | | |
| LC-MS, | compounds | | | |
| GC-MS | Non- | Max 0.5 | NMT 50 | Pass |
| | genotoxic | μg/day | μg/day | |
| | risk | | | |
| | compounds | | | |
| | Unknown | Identified as | NMT 50 | Pass |
| | compounds | non- | μg/day | |
| | | genotoxic | | |
| | | based on | | |
| | | their | | |
| | | matching | | |
| | | spectrogram. | | |
| | | Max 0.7 | | |
| | | μg/day | | |

Aspects

In a first aspect, the disclosure provides a porous membrane comprising poly(tetrafluoroethylene), wherein a) the membrane is at least partially coated with a polymer prepared from the free radical reaction of ethylenically-unsaturated monomers, wherein the monomers are comprised of monomers having an amide moiety; b) the membrane exhibits a wettability of at least about 80 Dynes/cm; and c) wherein the membrane exhibits a 60% isopropanol visual bubble point of greater than about 21 psi.

In a second aspect, the disclosure provides the porous membrane of the first aspect, wherein the membrane exhibits a deionized water flow time of about 200 to about 400 seconds, per 500 ml.

In a third aspect, the disclosure provides the porous membrane of the first aspect, wherein the mean pore size of the membrane is about 0.1 μm to about 0.2 μm.

In a fourth aspect, the disclosure provides the porous membrane of the first or second aspect, wherein the mean pore size of the membrane is about 0.15 μm to about 0.22 μm.

In a fifth aspect, the disclosure provides the membrane of any one of the first through the fourth aspects, wherein the membrane exhibits a wettability of about 82 to about 89 Dynes/cm.

In a sixth aspect, the disclosure provides the membrane of any one of the first through the fifth aspects, wherein the coating has an amide density (AD) of about 0.008 to about 0.014.

In a seventh aspect, the disclosure provides the membrane of any one of the first through the sixth aspects, wherein the monomers having an amide moiety are selected from the group consisting of ethyl acrylamide, butyl acrylamide, N, N-dimethylaminopropyl methacrylamide, acrylamide, methacrylamide, ethyl formamide, N-(2-methoxyacrylamido-ethyl)ethylene urea, N,N-methylenebisacrylamide, dimethylacrylamide and combinations thereof.

In an eighth aspect, the disclosure provides the membrane of any one of the first through the seventh aspects, wherein the monomers having an amide moiety are selected from the group consisting of N, N-methylenebisacrylamide, dimethylacrylamide, and a combination thereof.

In a ninth aspect, the disclosure provides the membrane of any one of the first through the eighth aspects, wherein at least about 90 mole percent of the monomers possess an amide moiety.

In a tenth aspect, the disclosure provide the membrane of the eighth aspect, wherein the N,N-methylenebisacrylamide and dimethylacrylamide are used in a weight ratio of about 1:1 to about 1:4.

In an eleventh aspect, the disclosure provides the membrane of any one of the first through the tenth aspects, wherein the coating has an amide density (AD) of about 0.010 to about 0.013.

In a twelfth aspect, the disclosure provides a filter comprising the membrane of any one of the first through the eleventh aspects.

In a thirteenth aspect, the disclosure provides a method for filtering a liquid, which comprises passing the liquid through the membrane of any one of the first through the eleventh aspects, or the filter of the twelfth aspect.

In a fourteenth aspect, the disclosure provides the method of thirteenth aspect, wherein the liquid comprises one or more of n-butyl acetate, isopropyl alcohol, 2-ethoxyethyl acetate, xylenes, cyclohexanone, ethyl lactate, isopentyl ether, methyl-2-hydroxyisobutyrate, methyl isobutyl carbinol, methyl isobutyl ketone, isoamyl acetate, undecane, propylene glycol methyl ether, propylene glycol monomethyl ether acetate, and a mixed solution of propylene glycol monomethyl ether and propylene glycol monomethyl ether acetate.

In a fifteenth aspect, the disclosure provides a method for removing bacteria from a liquid comprising at least one active pharmaceutical ingredient and one or more carriers and/or diluents, which comprises passing the liquid through the membrane of any one of the first through the eleventh aspects or the filter of the twelfth aspect.

In a sixteenth aspect, the disclosure provides the method of the fifteenth aspect, wherein the liquid comprises water.

In a seventeenth aspect, the disclosure provides the method of the sixteenth aspect, wherein the liquid further comprises one or more glycols or alcohols.

In an eighteenth aspect, the disclosure provides the method of the seventeenth aspect, wherein the liquid further comprises one or more of propylene glycol, glycerol, C₁-C₄ alcohols, or combinations thereof.

In a nineteenth aspect, the disclosure provides the method of the eighteenth aspect, wherein the liquid comprises water and at least one glycol chosen from propylene glycol and glycerol.

Having thus described several illustrative embodiments of the present disclosure, those of skill in the art will readily appreciate that yet other embodiments may be made and used within the scope of the claims hereto attached. Numerous advantages of the disclosure covered by this document have been set forth in the foregoing description. It will be understood, however, that this disclosure is, in many respects, only illustrative. The disclosure's scope is, of course, defined in the language in which the appended claims are expressed.

1. A porous membrane comprising poly(tetrafluoroethylene), wherein:
a) the membrane is at least partially coated with a polymer prepared from the free radical reaction of ethylenically-unsaturated monomers, wherein the monomers are comprised of monomers having an amide moiety;
b) the membrane exhibits a wettability of at least about 80 Dynes/cm; and
c) the membrane exhibits a 60% isopropanol visual bubble point of greater than about 21 psi.

2. The porous membrane of claim 1, wherein the membrane exhibits a deionized water flow time of about 200 to about 400 seconds, per 500 ml.

3. The porous membrane of claim 1, wherein the mean pore size of the membrane is about 0.1 μm to about 0.2 μm.

4. The porous membrane of claim 1, wherein the mean pore size of the membrane is about 0.15 μm to about 0.22 μm.

5. The membrane of claim 1, wherein the membrane exhibits a wettability of about 82 to about 89 Dynes/cm.

6. The membrane of claim 1, wherein the coating has an amide density (AD) of about 0.008 to about 0.014.

7. The membrane of claim 6, wherein the coating has an amide density (AD) of about 0.010 to about 0.013.

8. The membrane of claim 1, wherein the monomers having an amide moiety are selected from the group consisting of ethyl acrylamide, butyl acrylamide, N, N-dimethylaminopropyl methacrylamide, acrylamide, methacrylamide, ethyl formamide, N-(2-methoxyacrylamido-ethyl)ethylene urea, N,N-methylenebisacrylamide, dimethylacrylamide, and combinations thereof.

9. The membrane of claim 1, wherein the monomers having an amide moiety are selected from the group consisting of N, N-methylenebisacrylamide and dimethylacrylamide, and a combination thereof.

10. The membrane of claim 9, wherein the N,N-methylenebisacrylamide and dimethylacrylamide are used in a weight ratio of about 1:1 to about 1:4.

11. The membrane of claim 1, wherein at least about 90 mole percent of the monomers possess an amide moiety.

12. A filter comprising the membrane of claim 1.

13. A method for filtering a liquid, which comprises passing the liquid through the membrane of claim 1.

14. The method of claim 13, wherein the liquid comprises one or more of n-butyl acetate, isopropyl alcohol, 2-ethoxyethyl acetate, xylenes, cyclohexanone, ethyl lactate, isopentyl ether, methyl-2-hydroxyisobutyrate, methyl isobutyl carbinol, methyl isobutyl ketone, isoamyl acetate, undecane, propylene glycol methyl ether, propylene glycol monomethyl ether acetate, and a mixed solution of propylene glycol monomethyl ether and propylene glycol monomethyl ether acetate.

15. A method for removing bacteria from a liquid comprising at least one active pharmaceutical ingredient and one or more carriers and/or diluents, the method comprising passing the liquid through the membrane of claim 1.

16. The method of claim 15, wherein the liquid comprises water.

17. The method of claim 16, wherein the liquid further comprises one or more glycols or alcohols.

18. The method of claim 17, wherein the liquid further comprises one or more of propylene glycol, glycerol, C₁-C₄ alcohols, or combinations thereof.

19. The method of claim 18, wherein the liquid comprises water and at least one glycol chosen from propylene glycol and glycerol.
